(19) United States
(12) Patent Application Publication
(10) Pub. No.: US 2026/0073034 A1
(43) Pub. Date: Mar. 12, 2026

(54) ELECTRONIC DEVICE FOR PERFORMING SUBSCRIBER IDENTITY MODULE AUTHENTICATION, AND OPERATING METHOD AND STORAGE MEDIUM THEREOF

(71) Applicant: SAMSUNG ELECTRONICS CO., LTD., Suwon-si (KR)

(72) Inventors: Youngho HWANG, Suwon-si (KR); Taejune KIM, Suwon-si (KR); Dongwon SEO, Suwon-si (KR); Hyungchul JUNG, Suwon-si (KR)

(73) Assignee: SAMSUNG ELECTRONICS CO., LTD., Suwon-si (KR)

(21) Appl. No.: 19/327,632

(22) Filed: Sep. 12, 2025

Related U.S. Application Data
(63) Continuation of application No. PCT/KR2025/011953, filed on Aug. 7, 2025.

(30) Foreign Application Priority Data
Sep. 12, 2024 (KR) 10-2024-0124781
Oct. 25, 2024 (KR) 10-2024-0147462

(51) Int. Cl. G06F 21/36; G06F 21/60; H04W 12/72

(52) U.S. Cl. CPC G06F 21/36; G06F 21/602; H04W 12/72

(57) ABSTRACT

An electronic device includes: a communication circuit; a display; at least one processor including processing circuitry; and memory storing instructions that, when executed by the at least one processor individually or collectively, cause the electronic device to: display a lock screen for user authentication through the display based on an event for subscriber identity module (SIM) authentication being generated, acquire a personal identification number (PIN) for an SIM unlock based on acquisition of user authentication information for releasing the lock screen, identify whether the acquired PIN corresponds to a stored PIN, and perform the SIM unlock, based on identifying that the acquired PIN corresponds to the stored PIN.

### CROSS-REFERENCE TO RELATED APPLICATION(S)

This application is a by-pass continuation application of International Application No. PCT/KR2025/011953, filed on Aug. 7, 2025, which is based on and claims priority to Korean Patent Application No. 10-2024-0124781, filed in the Korean Intellectual Property Office on Sep. 12, 2024, and Korean Patent Application No. 10-2024-0147462, filed in the Korean Intellectual Property Office on Oct. 25, 2024, the disclosures of which are incorporated by reference herein in their entireties.

### BACKGROUND

### 1. Field

The disclosure relates to an electronic device for performing subscriber identity module (SIM) authentication, and an operating method and storage medium thereof.

### 2. Description of Related Art

In a wireless communication system, an electronic device (e.g., a user equipment (UE)) may access a wireless communication network to use a voice communication or data communication service at a predetermined location or during movement. In order to provide a communication service to an electronic device, an appropriate authentication process may be required. For example, a universal integrated circuit card (UICC) is inserted into the electronic device, and authentication may be performed between the electronic device and the server of a mobile network operator (MNO) through a universal subscriber identity module (USIM) installed inside the UICC. The UICC may be referred to as a subscriber identity module (SIM) card in a global system for mobile communications (GSM) scheme, and may be called a universal subscriber identity module (USIM) card in a wideband code division multiple access (WCDMA), long-term evolution (LTE), or new radio (NR) scheme.

A portable electronic device may include a storage medium such as a subscriber identity module (or a user authentication module card) or a memory card. The storage medium may be embedded into the electronic device or may be configured to be replaced and/or added easily by the user. For example, the electronic device may include a removable tray in the housing, and the storage medium may be coupled to the electronic device while being disposed on the tray.

When the user of the electronic device subscribes to the wireless communication service provided by the MNO, the MNO may provide the UICC (e.g., the SIM card or the USIM card) to the user and the user may insert the provided UICC into the electronic device. When the UICC is inserted into the electronic device, a USIM application installed in the UICC may be executed, and an appropriate authentication process using an international mobile subscriber identity (IMSI) value and an encryption key for authentication stored in the UICC may be performed with the server of the MNO storing the same values. After the appropriate authentication process, the wireless communication service may be used.

The information may be provided as the related art to help understanding of the disclosure. Any opinion or decision on whether the above-mentioned content can be applied as the prior art related to the disclosure has not been provided.

### SUMMARY

According to an aspect of the disclosure, an electronic device includes: a communication circuit; a display; at least one processor including processing circuitry; and memory storing instructions that, when executed by the at least one processor individually or collectively, cause the electronic device to: display a lock screen for user authentication through the display based on an event for subscriber identity module (SIM) authentication being generated, acquire a personal identification number (PIN) for an SIM unlock based on acquisition of user authentication information for releasing the lock screen, identify whether the acquired PIN corresponds to a stored PIN, and perform the SIM unlock, based on identifying that the acquired PIN corresponds to the stored PIN.

The instructions, when executed by the at least one processor individually or collectively, cause the electronic device to: display a user interface for acquisition of the user authentication information through the display based on identification of an event for activating a SIM authentication function using an auto-generated PIN (AGP), acquire the user authentication information based on an input to the user interface for acquisition of the user authentication information, acquire identification information of the electronic device and identification information of the SIM based on user authentication being performed using the user authentication information, acquire a PIN for configuration of SIM authentication information based on (i) the identification information of the electronic device, (ii) the identification information of the SIM, and (iii) a random value, and store the PIN for configuration of the SIM authentication information.

The instructions, when executed by the at least one processor individually or collectively, cause the electronic device to: acquire the identification information of the electronic device and the identification information of the SIM based on acquistion of the user authentication information for releasing the lock screen, acquire the PIN for the SIM unlock based on (i) the identification information of the electronic device, (ii) the identification information of the SIM, and (iii) the random value, and establish a connection with a network through the communication circuit based on the PIN for the SIM unlock corresponding to the stored PIN.

The instructions, when executed by the at least one processor individually or collectively, cause the electronic device to: store, in the memory, an encrypted random value acquired using a key for encrypting the random value or decrypting the encrypted random value, acquire a decrypted random value by using the key on the encrypted random value based on acquisition of the user authentication information for releasing the lock screen, and acquire the PIN for the SIM unlock based on (i) the identification information of the electronic device, (ii) the identification information of the SIM, and (iii) the decrypted random value.

The instructions, when executed by the at least one processor individually or collectively, cause the electronic device to: identify whether the user authentication information for user authentication is configured based on identification of the event for activating an SIM authentication function using the PIN, display a user interface for configuration of the user authentication information through the display based on identifying that the user authentication information for user authentication is not configured, acquire the user authentication information based on an input to the user interface, and store the acquired user authentication information in the memory.

The instructions, when executed by the at least one processor individually or collectively, cause the electronic device to: display a user interface for acquisition of the user authentication information through the display based on acquisition of an input for displaying the stored PIN, acquire the user authentication information based on the input to the user interface, and display a user interface comprising the stored PIN through the display based on identifying that the acquired user authentication information corresponds to stored user authentication information.

The instructions, when executed by the at least one processor individually or collectively, cause the electronic device to: acquire, after displaying the user interface comprising the stored PIN, an updated PIN using a different random value generated from the random value, and configure the updated PIN as the PIN for the SIM unlock.

The instructions, when executed by the at least one processor (240) individually or collectively, cause the electronic device to: deactivate a function related to an SIM lock based on identificiation of an event for deactivating the SIM authentication function using the AGP, the function related to the SIM lock deactivated by changing the stored PIN to a configured value, display, while the function related to the SIM lock is deactivated, the user interface for acquisition of the user authentication information through the display based on identification of an event for activating the SIM authentication function using a manual PIN, acquire the user authentication information based on an input to the user interface, display a user interface for acquisition of the manual PIN through the display based on the user authentication information corresponding to the stored user authentication information, and configure the manual PIN acquired based on an input to the user interface for acquisition of the manual PIN as the PIN for the SIM unlock.

The instructions, when executed by the at least one processor individually or collectively, cause the electronic device to: display a user interface for acquisition of a PIN through the display, identify whether the PIN input to the user interface corresponds to the stored PIN, and perform an operation related to SIM lock based on identifying that the PIN acquired based on the input does not correspond to the stored PIN.

The identification information of the electronic device comprises an international mobile equipment identity (IMEI) of the electronic device, the identification information of the SIM comprises an integrated circuit card identifier (ICCID) of the SIM, and the instructions, when executed by the at least one processor individually or collectively, cause the electronic device to: input the IMEI, the ICCID, and the random value into a key derivation function to acquire the PIN for the SIM unlock based on information output from the key derivation function.

The instructions, when executed by the at least one processor individually or collectively, cause the electronic device to: start a timer for periodically updating the PIN based on acquisition of the PIN for the SIM unlock, acquire, based on elapse of a time interval corresponding to the timer, an updated PIN based on a different random value generated from the random value, and configure the updated PIN as the PIN for the SIM unlock.

The instructions, when executed by the at least one processor individually or collectively, cause the electronic device to: convert the acquired PIN into an encrypted PIN based on the acquired PIN corresponding to the stored PIN, and transmit the encrypted PIN to a cloud server through the communication circuit.

The event for an SIM authentication comprises an event of insertion of the SIM into the electronic device.

The event for the SIM authentication comprises an event of rebooting the electronic device.

According to an aspect of the disclosure, a method for operating an electronic device includes displaying a lock screen for user authentication through a display of the electronic device based on an event for subscriber identity module (SIM) authentication being generated; acquiring a personal identification number (PIN) for an SIM unlock based on acquiring user authentication information for releasing the lock screen; identifying whether the acquired PIN corresponds to a stored PIN; and performing the SIM unlock, based on identification that the acquired PIN corresponds to the stored PIN.

The method further includes displaying a user interface for acquisition of the user authentication information through the display based on identifying an event for activating a SIM authentication function using an auto-generated PIN (AGP); acquiring the user authentication information based on an input to the user interface; acquiring identification information of the electronic device and identification information of the SIM based on user authentication being performed using the user authentication information; acquiring a PIN for configuration of SIM authentication information based on (i) the identification information of the electronic device, (ii) the identification information of the SIM, and (iii) a random value; and storing the PIN for configuration of the SIM authentication information.

The acquiring of the PIN for the SIM unlock based on acquiring the user authentication information for releasing the lock screen, further includes: acquiring the identification information of the electronic device and the identification information of the SIM based on acquiring the user authentication information for releasing the lock screen; and acquiring the PIN for the SIM unlock based on (i) the identification information of the electronic device, (ii) the identification information of the SIM, and (iii) the random value, and the method further includes: establishing a connection with a network through a communication circuit of the electronic device, based on the PIN for the SIM unlock corresponding to the stored PIN.

The method further includes storing, in memory of the electronic device, an encrypted random value acquired using a key for encrypting the random value or decrypting the encrypted random value, the acquiring of the PIN for the SIM unlock based on the user authentication information for releasing the lock screen being acquired, further comprises: acquiring a decrypted random value by using the key on the encrypted random value based on the user authentication information for releasing the lock screen being acquired; and acquiring the PIN for the SIM unlock based on (i) the identification information of the electronic device, (ii) the identification information of the SIM, and (iii) the decrypted random value.

The method further includes identifying whether the user authentication information for user authentication is configured based on identifying the event for activating an SIM authentication function using the PIN; displaying a user interface for configuration of the user authentication information through the display based on identifying that the user authentication information for the user authentication is not configured; acquiring the user authentication information, based on an input to the user interface for configuration of the user authentication information; and storing the acquired user authentication information in the memory of the electronic device.

According to an aspect of the disclosure, a non-transitory computer-readable storage medium recording computer-executable instructions, the computer-executable instructions, when executed by at least one processor including processing circuitry of an electronic device individually or collectively, causing the electronic device to: display a lock screen for user authentication through a display of the electronic device, based on an event for subscriber identity module (SIM) authentication being generated, acquire a personal identification number (PIN) for an SIM unlock, based on acquisition of user authentication information for releasing the lock screen, identify whether the acquired PIN corresponds to a stored PIN, and perform the SIM unlock, based on identifying that the acquired PIN corresponds to the stored PIN.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device within a network environment according to one or more embodiments.

FIG. 2 is a block diagram of the electronic device according to an embodiment.

FIG. 3 is a block diagram of a framework of the electronic device according to an embodiment.

FIG. 4 is a flowchart illustrating a method of performing SIM authentication by the electronic device according to an embodiment.

FIG. 5A illustrates a method of performing SIM authentication by the electronic device according to an embodiment.

FIG. 5B illustrates a method of performing SIM authentication by the electronic device according to an embodiment.

FIG. 6A illustrates a method of configuring a SIM PIN by the electronic device according to an embodiment.

FIG. 6B illustrates a method of configuring a SIM PIN by the electronic device according to an embodiment.

FIG. 7 is a flowchart illustrating a method of configuring the PIN of the electronic device according to an embodiment.

FIG. 8 illustrates a method of activating a SIM authentication function using the PIN by the electronic device according to an embodiment.

FIG. 9 is a flowchart illustrating a method of providing a stored PIN by the electronic device according to an embodiment.

FIG. 10 illustrates a method of providing the stored PIN by the electronic device according to an embodiment.

FIG. 11 is a flowchart illustrating a method of configuring the PIN by the electronic device according to an embodiment.

FIG. 12 illustrates a method of configuring the PIN by the electronic device according to an embodiment.

FIG. 13 is a flowchart illustrating a method of transmitting the PIN by the electronic device to a cloud server according to an embodiment.

FIG. 14 illustrates a method of activating a PIN management function through a cloud server by the electronic device according to an embodiment.

FIG. 15 illustrates a method of backing up or restoring the PIN through the cloud server by the electronic device according to an embodiment.

FIG. 16 illustrates a method of acquiring the PIN by the electronic device according to an embodiment.

FIG. 17 illustrates a method of performing SIM authentication by the electronic device according to an embodiment.

FIG. 18 illustrates a method of performing SIM authentication by using information acquired by another electronic device of the user of the electronic device according to an embodiment.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and B,” “at least one of A or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, embodiments of the disclosure will be described in detail with reference to the drawings so that those skilled in the art to which the disclosure pertains can easily implement the disclosure. However, the disclosure may be implemented in various forms and is not limited to embodiments set forth herein. With regard to the description of the drawings, the same or like reference signs may be used to designate the same or like elements. Also, in the drawings and the relevant descriptions, description of well-known functions and configurations may be omitted for the sake of clarity and brevity.

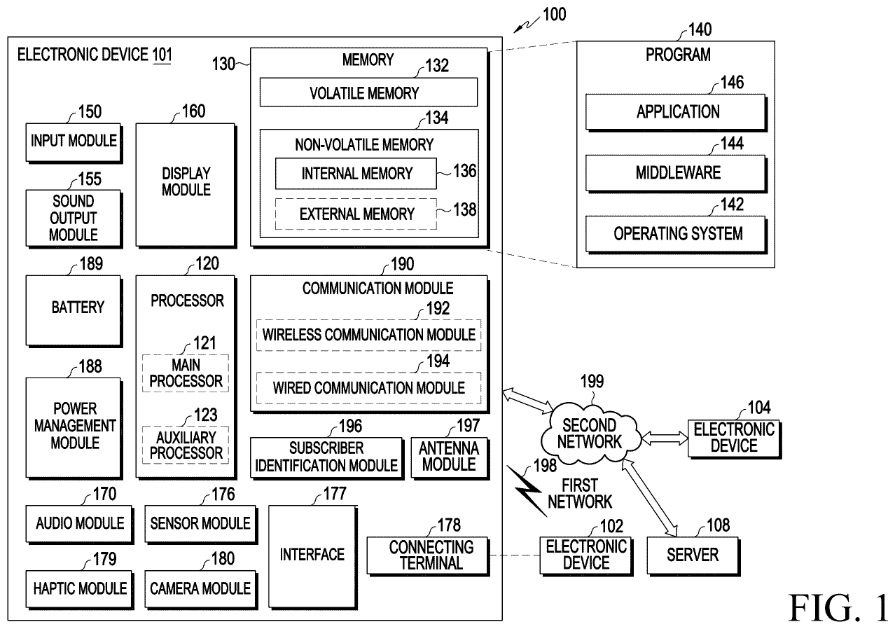

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

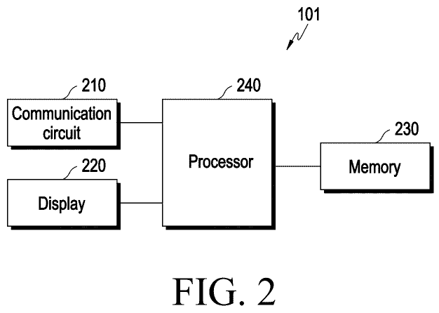

FIG. 2 is a block diagram of the electronic device according to an embodiment.

Referring to FIG. 2, in an embodiment, the electronic device 101 may be the electronic device 101 of FIG. 1.

In an embodiment, the electronic device 101 may include a communication circuit 210, a display 220, memory 230, and/or a processor 240.

In an embodiment, the communication circuit 210 may be included in the communication module 190 of FIG. 1.

In an embodiment, the display 220 may be included in the display module 160 of FIG. 1. The display 220 may display a user interface associated with a configuration for SIM card security.

In an embodiment, the memory 230 may be included in the memory 130 of FIG. 1.

In an embodiment, the memory 230 may store information for performing an operation of authenticating a subscriber identity module (SIM). For example, the memory 230 may store instructions for performing an operation of authenticating the SIM when executed by the processor 240.

In an embodiment, the processor 240 may be included in the processor 120 of FIG. 1.

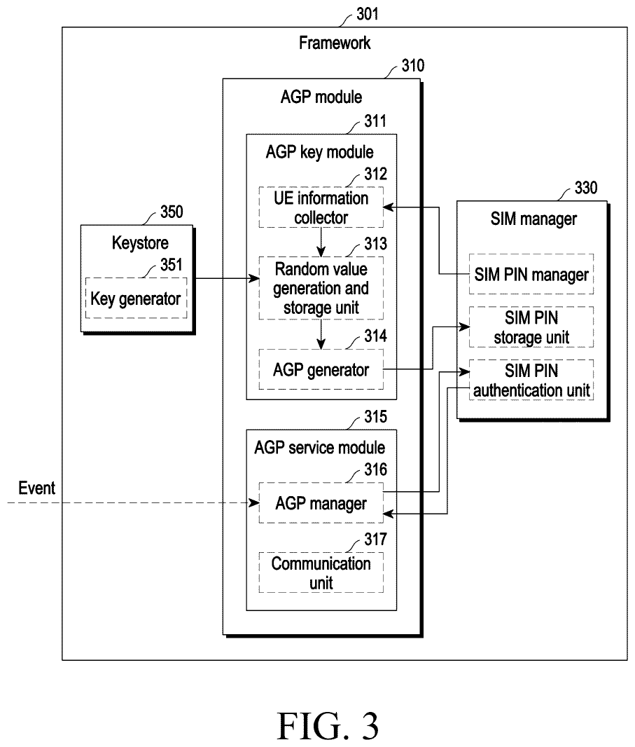

In an embodiment, the processor 240 (e.g., a processor including “processing circuitry”) may control the overall operation for authenticating the SIM. In an embodiment, the processor 240 may include one or more processors 240 for authenticating the SIM. For example, the processor 240 may correspond to a plurality of processors for performing a plurality of operations separately (or individually) or collectively between the processors 240. The operation in which the processor 240 authenticates the SIM is described below in detail with reference to FIGS. 3 to 18.

FIG. 2 illustrates that the electronic device 101 includes the communication circuit 210, the display 220, the memory 230, and/or the processor 240, but is not limited thereto. For example, the electronic device 101 may further include at least one element (e.g., the camera module 180) among the one or more elements of the electronic device 101 illustrated in FIG. 1. The electronic device 101 may be a portable electronic device capable of accommodating the SIM card. For example, the electronic device 101 may be a smartphone, a tablet, or a wearable electronic device (e.g., a smart watch or a video see-through (VST) device), but there is no limitation on a detailed example. As understood by one of ordinary skill in the art, the embodiments of the present disclosure are not limited to a single electronic device 101. For example, the embodiments may be implemented on a distributed architecture that includes multiple processors. Furthermore, the embodiments may be implemented in which one or more tasks are split between the electronic device 101 and a server on a cloud.

FIG. 3 is a block diagram of a framework of the electronic device according to an embodiment.

In an embodiment, the framework 301 of the electronic device (e.g., the electronic device 101 of FIG. 2) may include a plurality of modules. The plurality of modules may include, for example, an auto-generated PIN (AGP) module 310, a SIM manager 330, and/or a keystore 350. The framework 301 may be implemented as at least a part of the operating system (e.g., the operating system 142 of FIG. 1). In an embodiment, the plurality of modules included in the framework 301 (or framework layer) may be implemented in the form of an application, program, computer code, instructions, routines, processes, software, firmware, or a combination of at least two thereof that can be executed by a processor (e.g., the processor 240 of FIG. 2). For example, when at least one or more modules of the AGP module 310, the SIM manager 330, and/or the keystore 350 are executed, the processor may perform an operation corresponding to each thereof. Accordingly, hereinafter, the expression of “a specific module performs an operation” may be understood that “the processor performs an operation corresponding to a specific module according to execution of the specific module.” In an embodiment, at least some of the modules may include a plurality of programs but are not limited the above description. In an embodiment, modules and/or units may be implemented as services or applications when executed on the Android operating system, but there is no limitation thereon.

In an embodiment, the AGP module 310 may include an AGP key module 311 and an AGP service module 315. In an embodiment, a function provided by the AGP module 310 may be implemented through a menu of a security service such as auto blocker.

In an embodiment, the AGP key module 311 may generate a PIN (or AGP) and store the generated PIN. The AGP key module 311 may collect information for generating the PIN. The AGP key module 311 may acquire identification information of the electronic device 101 and identification information of the SIM (e.g., the subscriber identity module 196 of FIG. 1). The AGP key module 311 may generate a random value (or random) and encrypt the generated random value. The AGP key module 311 may store the encrypted random value. In one or more example, the AGP key module 311 may operate as a random number generator using a key as a seed to generate a random number.

In an embodiment, the AGP key module 311 may include a user equipment information collector 312, a random value generation and storage unit 313, and an AGP generator 314. The UE information collector 312 may acquire a parameter for generating the PIN (e.g., AGP). The parameter for generating the PIN may include identification information of the electronic device 101 and identification information of the SIM. The UE information collector 312 may acquire identification information of the electronic device 101 from a system (e.g., an application programming interface (API) associated with system attributes or a system attribute menu). The identification information of the electronic device 101 may be, for example, a product serial number of the electronic device 101 or an international mobile equipment identity (IMEI). The IMEI may be a 15 digit unique code that identifies a mobile device and may be used for tracking, security, and network identification. However, the embodiments are not limited to these configurations and may include any suitable identity information known to one of ordinary skill in the art. The UE information collector 312 may acquire identification information of the SIM from a SIM PIN manager of the SIM. The identification information of the SIM may be an integrated circuit card identifier (ICCID) of the SIM, however, the embodiments are not limited to this configuration. The random value generation and storage unit 313 may generate a random value and store the generated random value. The random value generation and storage unit 313 may acquire a key for encrypting or decrypting the generated random value by the keystore 350 (e.g., a key generator 351). The random value generation and storage unit 313 may encrypt the random value by using the key. The random value generation and storage unit 313 may store the encrypted random value in a secure storage (e.g., the memory 130 of FIG. 1). When the PIN is generated by the AGP generator 314, the random value generation and storage unit 313 may decrypt the encrypted random value by using the key. The random value generation and storage unit 313 may acquire a random value from a parameter used to generate the PIN for SIM authentication, based on that information acquired by the UE information collector 312 can be exposed. The random value generation and storage unit 313 may generate a different PIN (e.g., AGP) whenever a random value is generated. The security may be improved in compared to the case where SIM unlock is performed based on a PIN for releasing a lock screen or a fixed SIM PIN. The AGP generator 314 may bind the identification information of the electronic device 101, the identification information of the SIM, and the random value. “An operation of binding information” may correspond to an operation of “inputting information for generating a PIN.” The AGP generator 314 may generate a PIN (e.g., AGP) by using a key derivation function such as a password-based key derivation function (PBKDF). The AGP generator 314 may provide the generated PIN to the SIM PIN storage unit of the SIM manager 330 so that the generated PIN is stored as the PIN of the SIM.

In an embodiment, the AGP service module 315 may compare the PIN (e.g., AGP′) generated by the AGP key module 311 with the stored PIN (e.g., AGP). The AGP service module 315 may call a user interface corresponding to the comparison result. The AGP service module 315 may back up the PIN in a server (e.g., the server 108 of FIG. 1), based on the comparison result or may restore the PIN from the server. The server may include, for example, a cloud server.

In an embodiment, the AGP service module 315 may include an AGP manager 316 and a communication unit 317. The AGP manager 316 may identify whether SIM PIN authentication is required based on the generation of an event for SIM authentication. The event for SIM authentication may include, for example, a rebooting event of the electronic device 101, an event of inserting (or attaching) the SIM into the electronic device 101, or an event of removing the SIM from the electronic device 101. However, the embodiments are not limited to these events where SIM authentication may be performed for any known events in which SIM authentication is suitable or appropriate. The AGP manager 316 may identify whether the SIM PIN has been authenticated. The AGP manager 316 may identify whether the stored PIN has expired based on validation of the stored PIN or based on that the stored PIN can be exposed. The AGP manager 316 may regenerate the PIN, based on identification that the stored PIN (or an expiration date of the AGP) has expired. The AGP manager 316 may provide the regenerated AGP to the SIM through the SIM manager 330 so that the PIN of the SIM is replaced by the regenerated AGP. The communication unit 317 may provide a function of backing up the generated PIN in the server (or cloud server) or restoring the PIN from the server. For example, the electronic device 101 may restore the PIN stored in the server, based on authentication of an account for the user of the electronic device 101.

In an embodiment, the AGP generated by the AGP module 310 may be provided through a user interface (e.g., show APG UI). For example, when the user of the electronic device 101 desires to insert the SIM into another electronic device, the PIN which is stored in the electronic device 101 (or which can be accessed by the electronic device 101) may be provided through the user interface. The stored PIN may be provided through the user interface, based on user authentication being performed.

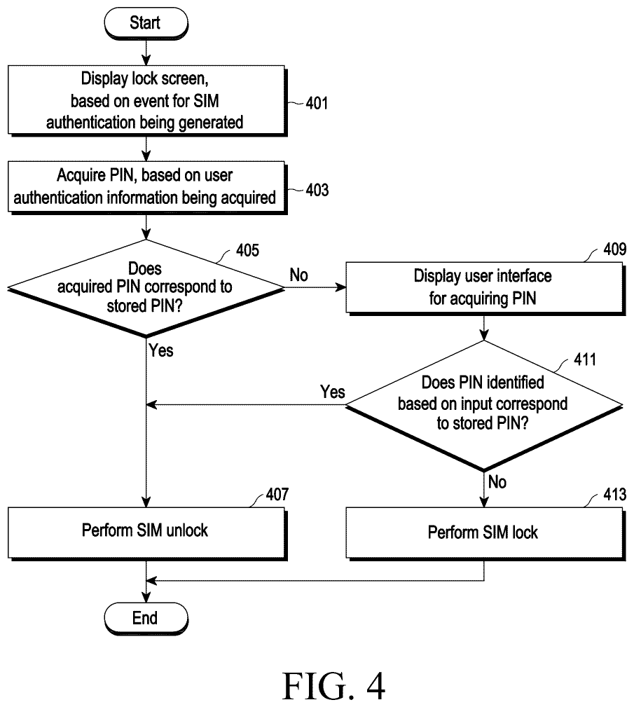

FIG. 4 is a flowchart illustrating a method of performing SIM authentication by the electronic device according to an embodiment.

In the following embodiments, respective operations may be sequentially performed but the sequential performance is not necessary. For example, orders of the operations may be changed, and at least two operations may be performed in parallel.

According to an embodiment, operations 401 to 413 may be understood as being performed by a processor (e.g., the processor 240 of FIG. 2) of an electronic device (e.g., the electronic device 101 of FIG. 2).

Referring to FIG. 4, in operation 401, the electronic device 101 (e.g., the processor 240) may display a lock screen, based on the generation of an event for SIM authentication in an embodiment. The event for SIM authentication may include, for example, a rebooting event of the electronic device 101, an event of inserting (or attaching) a SIM (e.g., the subscriber identity module 196 of FIG. 1) into the electronic device 101, or an event of removing the SIM from the electronic device 101, but there is no limitation. The lock screen may be a protection screen for receiving an input of user authentication information.

In operation 403, in an embodiment, the electronic device 101 may acquire the PIN, based on user authentication information being acquired. The electronic device 101 may acquire user authentication information, based on an input to the lock screen. The electronic device 101 may perform user authentication, based on the user authentication information. The electronic device 101 may acquire the PIN, based on user authentication being completed. The electronic device 101 may acquire the PIN for SIM unlock, based on identification information of the electronic device 101, identification information of the SIM, and a random value.

In operation 405, in an embodiment, the electronic device 101 may identify whether the acquired PIN corresponds to the stored PIN. The electronic device 101 may identify whether the PIN (e.g., AGP′) acquired based on the generation of the event for SIM authentication corresponds to pre-stored PIN (e.g., AGP). The electronic device 101 may compare, for example, an auto-generated PIN (AGP′) acquired based on the generation of the event for SIM authentication with a pre-stored auto-generated PIN (AGP).

In an embodiment, based on the acquired PIN corresponding to the stored PIN (operation 405—Yes), the electronic device 101 may perform SIM unlock in operation 407. The electronic device 101 may establish, for example, the connection with the network. The electronic device 101 may perform operations that require establishment of the connection with the network of the MNO such as a call service, based on the SIM being unlocked. The electronic device 101 may provide a home screen, based on a lock screen being released according to user authentication information.

In an embodiment, the electronic device 101 may combine an authentication process based on the SIM PIN and an authentication process through a lock screen. In order to handle SIM swapping attack, the electronic device 101 may generate a PIN (e.g., AGP) by using a key derivation function such as a password-based key derivation function (PBKDF), based on UE information of the user (e.g., IMEI), SIM information (e.g., ICCID), and random and replace SIM PIN authentication based on sequential inputs through a link with a lock screen function. The electronic device 101 may perform SIM unlock, based on the PIN comparison operation without sequentially receiving inputs of the SIM PIN and the user authentication information from the user. The user of the electronic device 101 may receive a service related to the SIM provided by the electronic device 101 in the state where the SIM unlock is completed based on only information for releasing the lock screen being input. The electronic device 101 may improve user experience by performing SIM unlock without two-factor authentication.

In an embodiment, based on identification that the acquired PIN does not correspond to the stored PIN (operation 405—No), the electronic device 101 may display a user interface for acquiring the PIN in operation 409. The electronic device 101 may display a user interface for acquiring the manual PIN, based on that the SIM unlock cannot be performed using the auto-generated PIN (AGP′) acquired based on, for example, the event for SIM authentication being generated.

In operation 411, in an embodiment, the electronic device 101 may identify whether the PIN identified based on the input corresponds to the stored PIN. The electronic device 101 may receive the input of the PIN provided by, for example, another electronic device (e.g., an electronic device operating based on the same user account as that of the electronic device 101) or the cloud server. The electronic device 101 may identify whether the PIN corresponding to the input corresponds to the stored PIN.

In an embodiment, based on identification that the PIN identified based on the input corresponds to the stored PIN (operation 411—Yes), the electronic device 101 may perform SIM unlock in operation 407. Based on identification that the PIN identified based on the input does not correspond to the stored PIN (operation 411—No), the electronic device 101 may perform SIM lock in operation 413. When the SIM authentication fails, the electronic device 101 may improve the security of the SIM by performing the operation related to the SIM lock if SIM swapping attack is attempted.

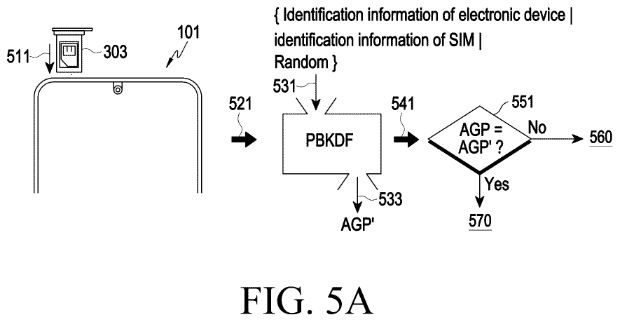

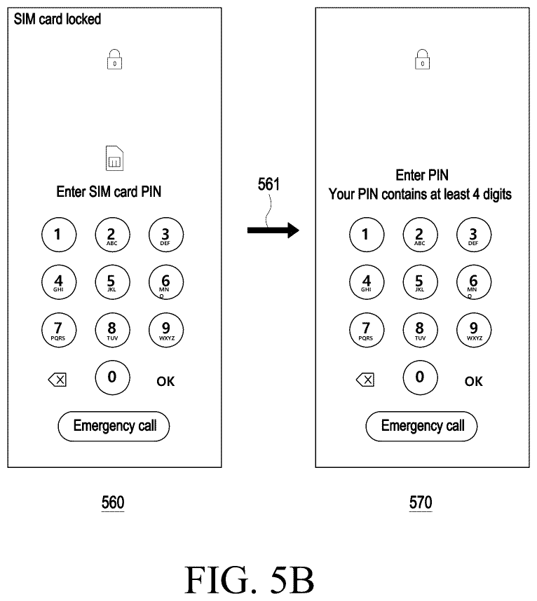

FIGS. 5A and 5B illustrate a method of performing SIM authentication by an electronic device according to an embodiment.

Referring to FIG. 5A, in an embodiment, the electronic device 101 may identify an event for SIM authentication. The electronic device 101 may identify the generation of, for example, an event of inserting (or attaching) a SIM (e.g., the subscriber identity module 196 of FIG. 1) into the electronic device 101 as indicated by reference numeral 511. The event for SIM authentication is not limited to the example of FIG. 5A. For example, the event for SIM authentication may be a rebooting event of the electronic device 101. In one or more examples, a rebooting event may occur when a device is restarted without turning on or off the device. In one or more examples, a rebooting event may occur when a device is turned off and then back on. In one or more examples a rebooting event may occur when a device is turned off for a predetermined amount of time and then turned back on. The electronic device 101 may acquire identification information of the electronic device 101 and identification information of the SIM, based on the event for SIM authentication as indicated by reference numeral 521. The electronic device 101 may acquire a random value to improve the security of the PIN for performing SIM authentication. The electronic device 101 may encrypt the random value or pre-store the encrypted random value acquired using a key for decrypting the encrypted random value. The electronic device 101 may acquire the encrypted random value by using the key, based on the event for SIM authentication being identified. The electronic device 101 may acquire the PIN for SIM unlock, based on the identification information of the electronic device 101, the identification information of the SIM, and the decrypted random value. The electronic device 101 may acquire the PIN (e.g., AGP′) for SIM unlock, based on information 533 output from the key derivation function, by inputting, for example, a parameter for generating the AGP into the key derivation function as indicated by reference numeral 531. The electronic device 101 may identify whether the acquired PIN corresponds to the stored PIN (e.g., AGP) as indicated by 551, based on the PIN for SIM unlock being acquired as indicated by reference numeral 541. The electronic device 101 may provide user interfaces 560 and 570 corresponding to the comparison result between the acquired PIN and the stored PIN.

Referring to FIG. 5B, when the PIN (e.g., AGP′) acquired based on the generation of the SIM authentication event corresponds to the stored PIN (e.g., AGP), the electronic device 101 may provide the lock screen 570. The electronic device 101 may perform SIM unlock, based on the lock screen 570 only being performed based on user authentication information. For example, the electronic device 101 may establish the connection with the network, based on the PIN for SIM unlock corresponding to the stored PIN. When the PIN (e.g., AGP′) acquired based on the generation of the SIM authentication event does not correspond to the stored PIN (e.g., AGP), the electronic device 101 may provide the screen 560 for receiving an input of the SIM PIN. The electronic device 101 may provide the lock screen 570, based on the input of the SIM PIN being received as indicated by reference numeral 561. When the AGP-based SIM authentication fails, the electronic device 101 may perform SIM unlock, based on SIM PIN authentication and lock screen authentication being sequentially performed. The PIN that requires the input during SIM PIN authentication may be a value corresponding to the pre-generated AGP. When the AGP-based SIM authentication fails, the input of the value corresponding to the AGP generated based on a random value is required, and thus, security of the SIM authentication may be improved.

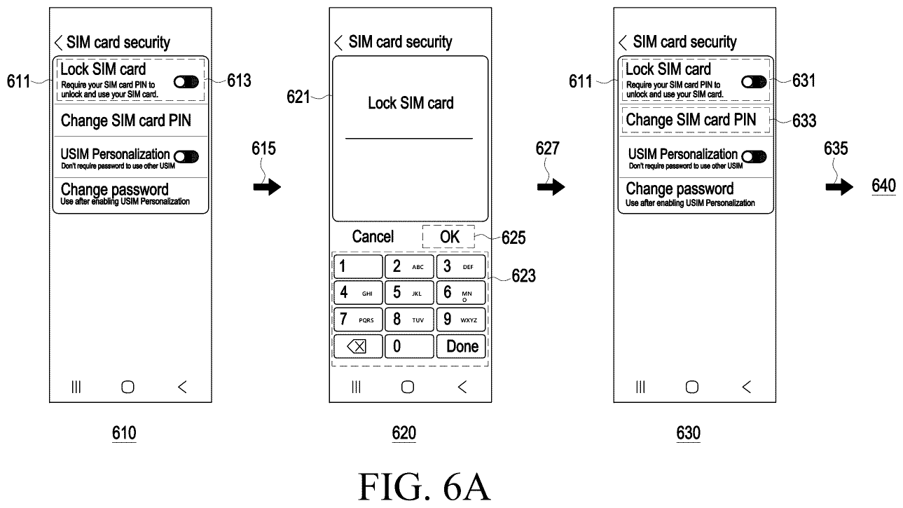

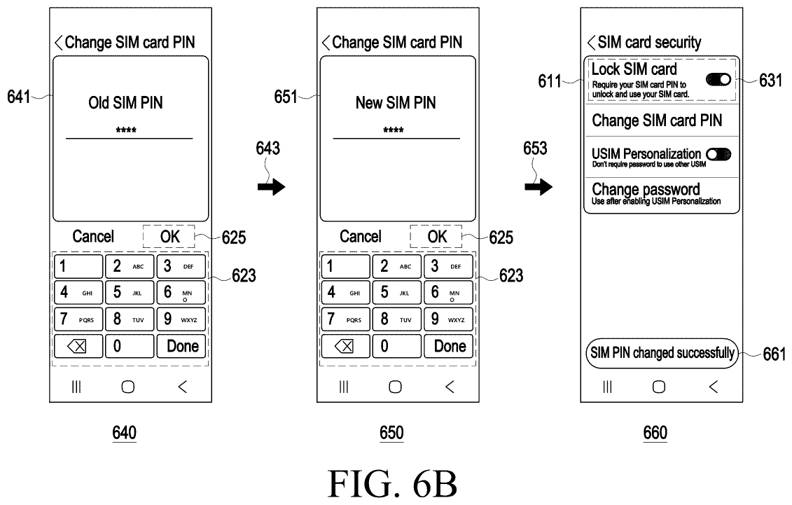

FIGS. 6A and 6B illustrate a method of configuring a SIM PIN by the electronic device according to an embodiment.

Referring to FIG. 6A, in an embodiment, the electronic device 101 may display a user interface 610 associated with a configuration for SIM card security through a display (e.g., the display 220 of FIG. 2). The user interface 610 associated with the configuration for SIM card security may include a window 611 for security functions such as a SIM lock function, a change in the PIN of the SIM card, personalization of the USIM, or a change in the password. The SIM lock function may be referred to as a “SIM card lock function.” The electronic device 101 may identify an event for activating the SIM lock function. The electronic device 101 may identify, for example, a touch event for an object 613 related to the SIM lock function (e.g., event where user explicitly activates the SIM lock function). The electronic device 101 may provide a user interface 620 for receiving an input of the SIM PIN, based on the event for activating the SIM lock function being identified as indicated by reference numeral 615. The electronic device 101 may display masked numbers or characters in a partial area 621 of the user interface 620, based on an input on a keypad 623 included in the user interface 620. The electronic device 101 may identify whether the input SIM PIN corresponds to an initially configured PIN, based on the touch event for an OK object 625. The electronic device 101 may display a user interface 630 indicating activation of the SIM lock function, based on the input SIM PIN corresponding to the initially configured PIN being identified as indicated by reference numeral 627. The user interface 630 may include an object 631 indicating activation of the SIM lock function. The electronic device 101 may identify a touch event for an object 633 related to a function of changing a SIM card PIN. The electronic device 101 may display a user interface 640 for receiving an input of the SIM PIN, based on the input on the object 633 being identified as indicated by reference numeral 635.

Referring to FIG. 6B, the user interface 640 may include a window 641 making a request for inputting the current SIM PIN. The electronic device 101 may identify whether the SIM PIN identified based on the input on the keypad object 623 corresponds to the current SIM PIN. The electronic device 101 may display a user interface 650 for receiving an input of a new SIM PIN, based on the input SIM PIN corresponding to the current SIM PIN being identified as indicated by reference numeral 643. The user interface 650 may include a window 651 making a request for inputting the new SIM PIN. The electronic device 101 may acquire the new SIM PIN, based on the input on the keypad object 623 as indicated by reference numeral 653. The electronic device 101 may store the new SIM PIN and display a user interface 660 including a message 661 indicating that the SIM PIN has successfully changed. In an embodiment, as illustrated in FIGS. 6A and 6B, when SIM authentication is performed based on the initially configured PIN or the PIN changed by the user, SIM PIN authentication and lock screen authentication may be sequentially performed.

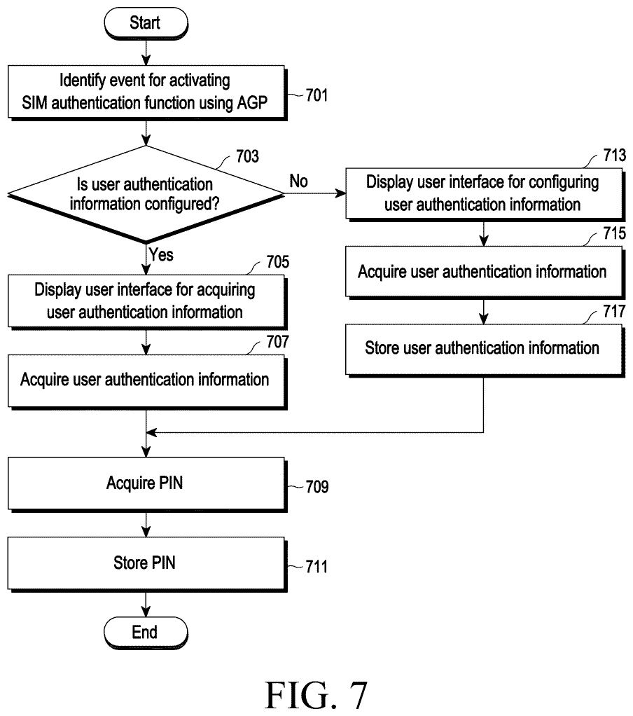

FIG. 7 is a flowchart illustrating a method of configuring the PIN by the electronic device according to an embodiment.

In the following embodiments, respective operations may be sequentially performed but the sequential performance is not necessary. For example, orders of the operations may be changed, and at least two operations may be performed in parallel.

According to an embodiment, operations 701 to 717 may be understood as being performed by a processor (e.g., the processor 240 of FIG. 2) of an electronic device (e.g., the electronic device 101 of FIG. 2).

Referring to FIG. 7, in operation 701, the electronic device 101 (e.g., the processor 240) may identify an event for activating a SIM authentication function using an auto-generated PIN (AGP) in an embodiment.

In operation 703, in an embodiment, the electronic device 101 may identify whether user authentication information is configured. The electronic device 101 may identify whether the user authentication information is configured based on high security being required for the SIM authentication function using the auto-generated PIN. The user authentication information may include information for releasing the lock screen. The user authentication information may include, for example, user authentication such as 3P (e.g., PIN, password, or pattern), but there is no limitation. The configuration of the user authentication information may be a configuration of the lock screen (or activation of the lock screen function).

In an embodiment, based on identification that user authentication information is configured (operation 703—Yes), the electronic device 101 may display a user interface for acquiring the user authentication information in operation 705. In operation 707, in an embodiment, the electronic device 101 may acquire the user authentication information.

In operation 709, in an embodiment, the electronic device 101 may acquire a PIN. The electronic device 101 may acquire identification information of the electronic device 101 and identification information of the SIM, based on user authentication using the user authentication information being performed. The electronic device 101 may collect information for acquiring an AGP, based on the user authentication information corresponding to stored user authentication information being identified. The electronic device 101 may acquire the PIN for configuring SIM authentication information, based on the identification information of the electronic device 101, the identification information of the SIM, and a random value. In operation 711, in an embodiment, the electronic device 101 may store the PIN. The electronic device 101 may store the PIN for configuring SIM authentication information.

In an embodiment, based on identification that the user authentication information is not configured (operation 703—No), the electronic device 101 may display a user interface for configuring the user authentication information in operation 713. In operation 715, in an embodiment, the electronic device 101 may acquire the user authentication information. The electronic device 101 may acquire the user authentication information, based on an input to the user interface. In operation 717, in an embodiment, the electronic device 101 may store the user authentication information. The electronic device 101 may acquire the PIN for SIM authentication based on the AGP, based on the user authentication information being stored.

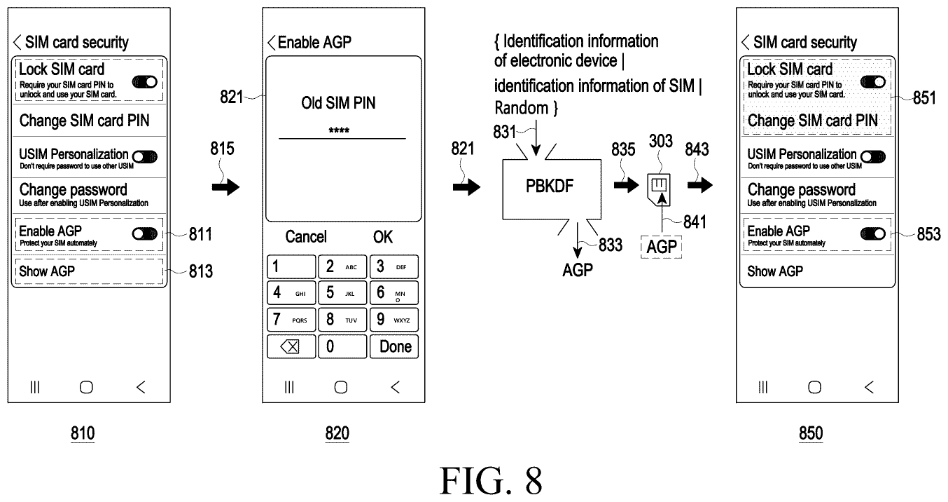

FIG. 8 illustrates a method of activating a SIM authentication function using the PIN by the electronic device according to an embodiment.

Referring to FIG. 8, the electronic device 101 may display a user interface 810 including objects 811 and 813 related to an AGP function. The electronic device 101 may display a user interface 820 including a window 821 asking an input of the SIM PIN, based on an input on the object 811 indicating whether to activate the AGP function being identified as indicated by reference numeral 815. The electronic device 101 may acquire the AGP, based on the current SIM PIN being received as indicated by reference numeral 821. The electronic device 101 may acquire a PIN for configuring SIM authentication information, based on information including identification information of the electronic device 101, identification information of the SIM, and a random value being input as indicated by reference numeral 831. The electronic device 101 may configure the acquired AGP as the SIM PIN corresponding to the SIM (e.g., the subscriber identity module 196 of FIG. 1) as indicated by reference numeral 841, based on the acquired PIN being stored as indicated by reference numeral 835. The electronic device 101 may display a user interface 850 including an object 853 indicating that the AGP function (or menu) has been activated, based on SIM authentication information based on the AGP being configured as indicated by reference numeral 843. In the user interface 850, the object 851 for configuring or changing the SIM card PIN may be processed to be dim.

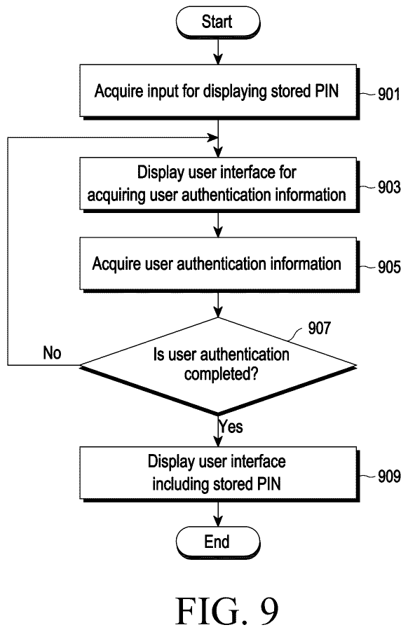

FIG. 9 is a flowchart illustrating a method of providing a stored PIN by the electronic device according to an embodiment.

In the following embodiments, respective operations may be sequentially performed but the sequential performance is not necessary. For example, orders of the operations may be changed, and at least two operations may be performed in parallel.

According to an embodiment, operations 901 to 909 may be understood as being performed by a processor (e.g., the processor 240 of FIG. 2) of an electronic device (e.g., the electronic device 101 of FIG. 2).

Referring to FIG. 9, in operation 901, the electronic device 101 (e.g., the processor 240) may acquire an input for displaying a stored PIN in an embodiment. For example, when the user of the electronic device 101 desires to change the device for accommodating the SIM into a new electronic device, the stored PIN may be identified using the electronic device 101.

In operation 903, in an embodiment, the electronic device 101 may display a user interface for acquiring user authentication information. The electronic device 101 may identify whether to display the AGP, based on the user authentication information in order to reduce risk that the PIN (e.g., AGP) is exposed to others other than the user.

In operation 905, in an embodiment, the electronic device 101 may acquire the user authentication information. In operation 907, in an embodiment, the electronic device 101 may identify whether user authentication is completed. The electronic device 101 may identify whether the acquired user authentication information corresponds to the stored user authentication information. In an embodiment, based on identification that the user authentication is not completed (operation 907—No), the electronic device 101 may display the user interface for acquiring the user authentication information in operation 903.

In an embodiment, based on identification that the user authentication is completed (operation 907—Yes), the electronic device 101 may display a user interface including the stored PIN in operation 909. The electronic device 101 may display the stored PIN (e.g., AGP), based on identification that the acquired user authentication information corresponds to the stored user authentication information.

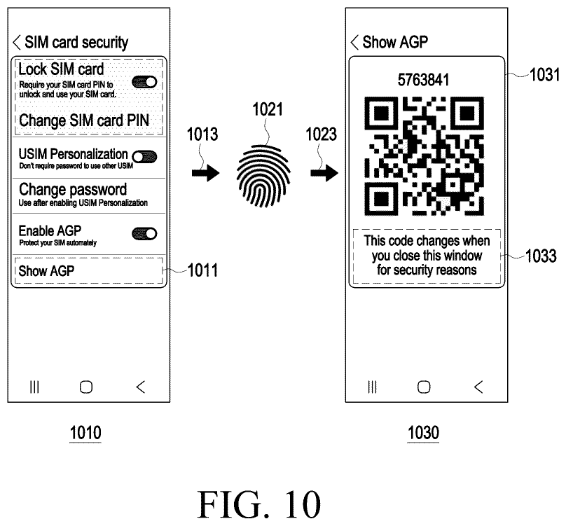

FIG. 10 illustrates a method of providing the stored PIN by the electronic device according to an embodiment.

Referring to FIG. 10, the electronic device 101 may display a user interface 1010 including an object 1011 for displaying an AGP. The electronic device 101 may acquire user authentication information 1021, based on identification that an input on the object 1011 being identified as indicated by reference numeral 1013. FIG. 10 illustrates that the user authentication information may be a fingerprint, but there is no limitation. The electronic device 101 may identify whether the acquired user authentication information 1021 corresponds to the stored user authentication information. The electronic device 101 may display a user interface 1030 including the AGP (or code indicating the AGP) 1031, based on identification that the acquired user authentication information 1021 corresponds to the stored user authentication information as indicated by reference numeral 1023. The user interface 1030 may display a message 1033 indicating that the code indicating the AGP can be changed.

In an embodiment, after displaying the user interface 1030 including the stored PIN, the electronic device 101 may acquire an updated PIN, based on a random value different from the random value corresponding to the stored PIN. The electronic device 101 may acquire the updated PIN by using the different random value, based on that a different AGP can be acquired depending on the random value for generating the AGP. The electronic device 101 may configure the updated PIN as the PIN for SIM unlock. The electronic device 101 may improve security by updating the PIN after providing the user interface 1030 including the stored PIN (or code indicating the AGP) without sequential touches for changing the PIN by the user.

In an embodiment, the electronic device 101 may periodically update the PIN. The electronic device 101 may initiate a timer for periodically updating the PIN, based on the PIN for SIM unlock being acquired. The electronic device 101 may acquire the updated PIN, based on a random value different from the random value corresponding to the stored PIN, based on the lapse of a time interval corresponding to the timer. The electronic device 101 may configure the updated PIN as the PIN for SIM unlock.

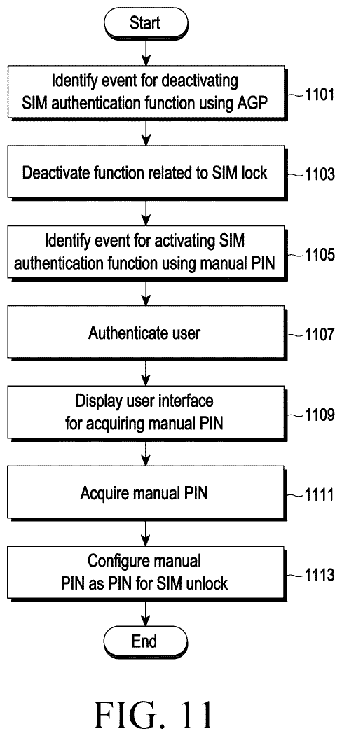

FIG. 11 is a flowchart illustrating a method of configuring the PIN by the electronic device according to an embodiment.

In the following embodiments, respective operations may be sequentially performed but the sequential performance is not necessary. For example, orders of the operations may be changed, and at least two operations may be performed in parallel.

According to an embodiment, operations 1101 to 1113 may be understood as being performed by a processor (e.g., the processor 240 of FIG. 2) of an electronic device (e.g., the electronic device 101 of FIG. 2).

Referring to FIG. 11, in operation 1101, the electronic device 101 (e.g., the processor 240) may identify an event for deactivating a SIM authentication function using an AGP in an embodiment.

In operation 1103, in an embodiment, the electronic device 101 may deactivate a function related to SIM lock. The electronic device 101 may deactivate the function related to SIM lock by changing the stored PIN into a configured value, based on the event for deactivating the SIM authentication function using an auto-generated PIN being identified. The operation of changing the stored PIN into the configured value may include an operation of removing (or discarding) the stored PIN or an operation of changing the stored PIN into a null value. The electronic device 101 may also deactivate the SIM lock function, based on the event for deactivating the SIM authentication function using the AGP being identified.

In operation 1105, in an embodiment, the electronic device 101 may identify an event for activating the SIM authentication function using a manual PIN. The electronic device 101 may display a user interface for acquiring user authentication information through a display (e.g., the display 220 of FIG. 2), based on the event for activating the SIM authentication function using the manual PIN being identified while the function related to SIM lock is deactivated. The electronic device 101 may identify, for example, the event for activating the function related to SIM lock. In operation 1107, in an embodiment, the electronic device 101 may perform user authentication. The electronic device 101 may activate the function related to the SIM lock after performing user authentication, based on a high security level being required for the function related to the SIM lock. The electronic device 101 may acquire user authentication information. The electronic device 101 may identify whether the acquired user authentication information corresponds to the stored user authentication information. The electronic device 101 may identify that user authentication is completed based on identification that the acquired user authentication information corresponds to the stored user authentication information.

In operation 1109, in an embodiment, the electronic device 101 may display the user interface for acquiring the manual PIN. In operation 1111, in an embodiment, the electronic device 101 may acquire the manual PIN, based on an input to the user interface for acquiring the manual PIN. In operation 1113, in an embodiment, the electronic device 101 may configure the manual PIN as a PIN for SIM unlock.

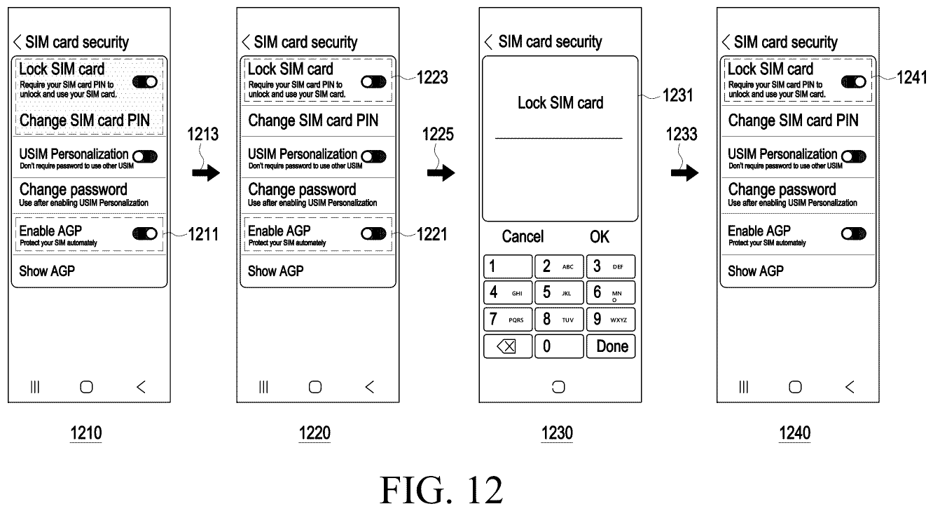

FIG. 12 illustrates a method of configuring the PIN by the electronic device according to an embodiment.

Referring to FIG. 12, in an embodiment, the electronic device 101 may identify an event for deactivating a SIM authentication function using an AGP, based on an input to a user interface 1210 related to a configuration for SIM card security. The electronic device 101 may deactivate both the SIM authentication function using AGP and the SIM lock function, based on an input on an object 1211 related to the SIM authentication function using AGP being identified as indicated by reference numeral 1213. A user interface 1220 may include objects 1221 and 1223 indicating that both the SIM authentication function using the AGP and the SIM lock function have been deactivated. The electronic device 101 may display a user interface 1230 including a window 1231 asking an input of an initially configured PIN, based on an input on the object 1223 related to the SIM lock function being identified as indicated by reference numeral 1225. The electronic device 101 may activate the SIM lock function, based on identification that the input PIN corresponds to the configured PIN as indicated by reference numeral 1233. The user interface 1240 may include an object 1241 indicating activation of the SIM lock function.

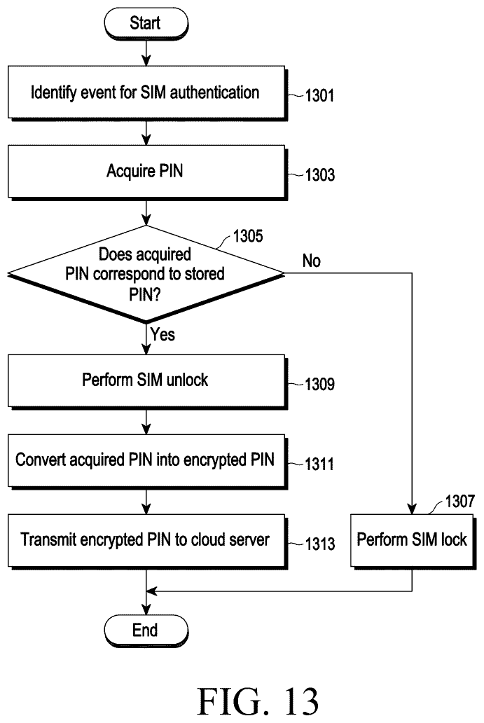

FIG. 13 is a flowchart illustrating a method of transmitting the PIN to a cloud server by the electronic device according to an embodiment.

In the following embodiments, respective operations may be sequentially performed but the sequential performance is not necessary. For example, orders of the operations may be changed, and at least two operations may be performed in parallel.

According to an embodiment, operations 1301 to 1313 may be understood as being performed by a processor (e.g., the processor 240 of FIG. 2) of an electronic device (e.g., the electronic device 101 of FIG. 2).

Referring to FIG. 13, in operation 1301, the electronic device 101 (e.g., the processor 240) may identify an event for SIM authentication in an embodiment. The event for SIM authentication may include a rebooting event of the electronic device 101, an event for inserting (or attaching) a SIM into the electronic device 101, or an event for removing the SIM from the electronic device 101, but there is no limitation.

In operation 1303, in an embodiment, the electronic device 101 may acquire a PIN, based on the event for SIM authentication being identified. The electronic device 101 may acquire the PIN for SIM unlock, based on identification information of the electronic device 101, identification information of the SIM, and a random value. In operation 1305, in an embodiment, the electronic device 101 may identify whether the acquired PIN corresponds to the stored PIN. The electronic device 101 may identify whether the acquired PIN (e.g., AGP′) corresponds to the configured PIN (e.g., AGP) based on the event for SIM authentication being identified. In an embodiment, based on identification that the acquired PIN does not correspond to the stored PIN (operation 1305—No), the electronic device may perform a SIM lock in operation 1307. The electronic device 101 may improve security by performing the SIM lock when the SIM authentication based on the AGP fails.

In an embodiment, based on identification that the acquired PIN corresponds to the stored PIN (operation 1305—Yes), the electronic device may perform SIM unlock in operation 1309.

In operation 1311, in an embodiment, the electronic device 101 may convert the acquired PIN into an encrypted PIN. The electronic device 101 may encrypt the acquired PIN so as to transmit the PIN through the network. In operation 1313, in an embodiment, the electronic device 101 may transmit the encrypted PIN to the cloud server. The electronic device 101 may restore a PIN (or identification information of a SIM identified from the PIN) transmitted from another electronic device, based on a user account.

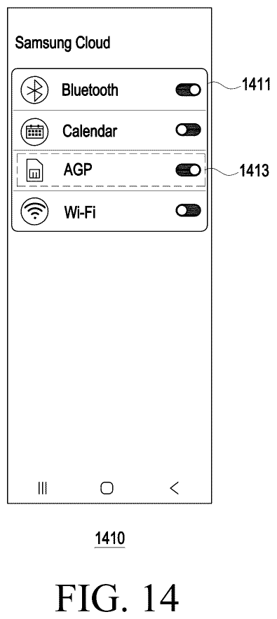

FIG. 14 illustrates a method of activating a PIN management function through a cloud server by the electronic device according to an embodiment.

Referring to FIG. 14, the electronic device 101 may display a user interface 1410 including a window 1411 related to a function of sharing information with another electronic device through the cloud server. The electronic device 101 may transmit the acquired AGP (or encrypted AGP) to the cloud server, based on an input on an object 1413 indicating whether to activate a backup function of the AGP using the cloud.

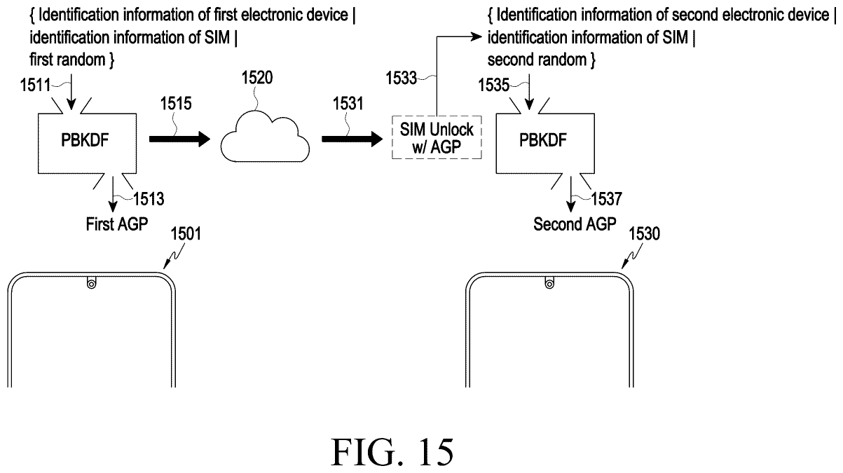

FIG. 15 illustrates a method of backing up or restoring the PIN through the cloud server by the electronic device according to an embodiment.

Referring to FIG. 15, a first electronic device 1501 may acquire a first AGP as indicated by reference numeral 1513, based on an input parameter 1511 including identification information of the first electronic device 1501, identification information of the SIM, and a first random value. The electronic device 101 may transmit the AGP to the cloud server 1520 as indicated by reference numeral 1515, based on the backup function of the AGP of FIG. 14 being activated. The electronic device 101 may transmit, for example, an encrypted AGP to the could server 1520. The operation of transmitting the encrypted AGP to the cloud server may be referred to as an operation of “performing end-to-end encrypted (E2EE) key backup.” After removing the SIM from the first electronic device 1501, a user of the first electronic device 1501 may insert the SIM into a new electronic device. For example, the SIM of the user may be inserted into a second electronic device 1530. The second electronic device 1530 may perform SIM authentication, based on information related to SIM authentication being received from the cloud server 1520 as indicated by reference numeral 1531 without manually receiving an input of the SIM PIN. The operation of receiving information related to SIM authentication from the cloud may be referred to as an operation of “performing end-to-end encrypted (E2EE) key restore.”

In an embodiment, the second electronic device 1530 may receive the encrypted AGP. The second electronic device 1530 may acquire the AGP, based on decryption of the encrypted AGP. The second electronic device 1530 may acquire identification information of the second electronic device 1530, identification information of the SIM, and a second random value as indicated by reference numeral 1533, based on the acquired AGP. The second electronic device 1530 may acquire a second AGP as indicated by reference numeral 1537, based on an input parameter 1535 including the identification information of the second electronic device 1530, the identification information of the SIM, and the second random value. The second electronic device 1530 may receive information configured by the cloud server 1520 as well as the AGP from the cloud server 1520.

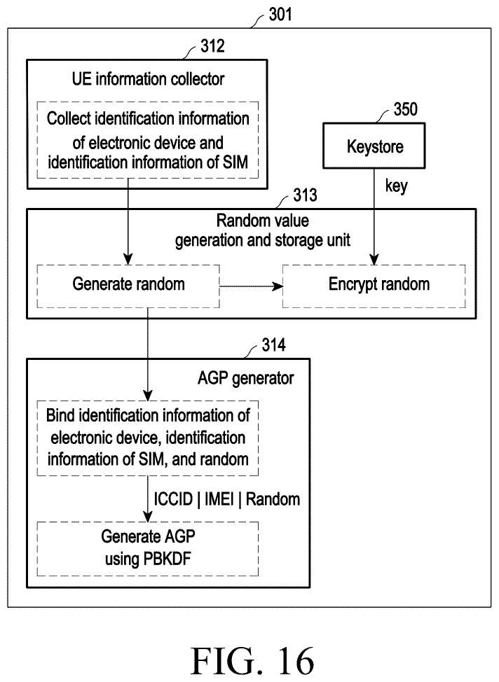

FIG. 16 illustrates a method of acquiring the PIN by the electronic device according to an embodiment.

Referring to FIG. 16, in an embodiment, the UE information collector 312 may collect identification information of the electronic device 101 and identification information of a SIM (e.g., the subscriber identity module 196 of FIG. 1). The electronic device 101 may perform lock screen authentication, based on an event for activating an AGP function being identified. The UE information collector 312 may collect the identification information of the electronic device 101 and the identification information of the SIM, based on lock screen authentication being performed.

The random value generation and storage unit 313 may generate a random value and encrypt the generated random value. The random value generation and storage unit 313 may encrypt the random value by using a key provided by the keystore 350. The random value generation and storage unit 313 may store the encrypted random value in a secure storage.

The AGP generator 314 may bind the identification information of the electronic device, the identification information of the SIM, and the random value. The AGP generator 314 may generate an AGP by using a PBKDF. The AGP generator 314 may transfer the generated AGP to the SIM. The AGP generator 314 may configure the generated AGP as a SIM PIN corresponding to the SIM.

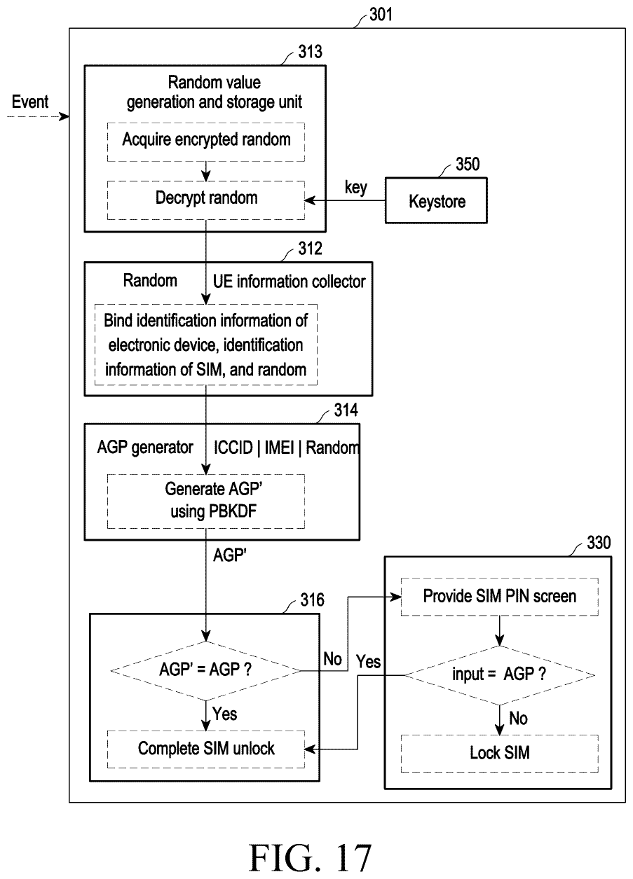

FIG. 17 illustrates a method of performing SIM authentication by the electronic device according to an embodiment.

Referring to FIG. 17, in an embodiment, the random value generation and storage unit 313 may acquire an encrypted random value from the secure storage (e.g., memory 130), based on an event for SIM authentication being identified. The random value generation and storage unit 313 may decrypt the encrypted random value by using the key provided by the keystore 350.

The UE information collector 312 may bind identification information of the electronic device 101, identification information of a SIM (e.g., the subscriber identity module 196 of FIG. 1), and a random value. The AGP generator 314 may generate an AGP′ by using a PBKDF. The AGP manager 316 may compare the generated AGP′ with the stored AGP. The AGP manager 316 may complete SIM unlock, based on identification that the generated AGP′ corresponds to the stored AGP. The SIM manager 330 may provide a SIM PIN screen, based on that the generated AGP′ does not correspond to the stored AGP. The SIM manager 330 may identify whether the input value corresponds to the AGP. The SIM manager 330 may complete SIM unlock, based on identification that the input value corresponds to the AGP. The SIM manager 330 may perform SIM lock, based on identification that the input value does not correspond to the AGP.

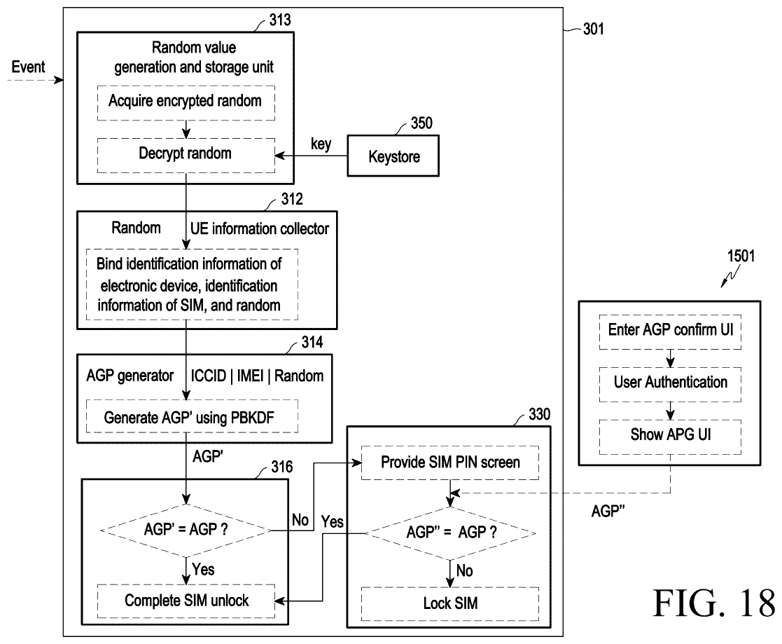

FIG. 18 illustrates a method of performing SIM authentication by using information acquired by another electronic device of the user of the electronic device according to an embodiment.

Referring to FIG. 18, in an embodiment, the random value generation and storage unit 313 may acquire an encrypted random value from the secure storage (e.g., memory 130), based on an event for SIM authentication being identified. The random value generation and storage unit 313 may decrypt the encrypted random value by using the key provided by the keystore 350.

The UE information collector 312 may bind identification information of the electronic device 101, identification information of a SIM (e.g., the subscriber identity module 196 of FIG. 1), and a random value. The AGP generator 314 may generate an AGP′ by using a PBKDF. The AGP manager 316 may compare the generated AGP′ with the stored AGP. The AGP manager 316 may complete SIM unlock, based on identification that the generated AGP′ corresponds to the stored AGP. The SIM manager 330 may provide a SIM PIN screen, based on that the generated AGP′ does not correspond to the stored AGP. In an embodiment, the user of the electronic device 101 may identify the AGP value by using another electronic device 1501 into which the SIM was previously inserted. For example, the user may acquire an AGP″ from the other electronic device by using a show AGP function. The electronic device 101 may receive an input of the AGP″ from the user. The electronic device 101 may receive the AGP″ from the other electronic device 1501. The SIM manager 330 may identify whether the input AGP″ corresponds to the AGP. The SIM manager 330 may complete SIM unlock, based on identification that the AGPP″ corresponds to the AGP. The SIM manager 330 may perform SIM lock, based on identification that the AGP″ does not correspond to the AGP.

An electronic device (e.g., the electronic device 101 of FIG. 2) according to an embodiment may include a communication circuit (e.g., the communication circuit 210 of FIG. 2). The electronic device 101 may include a display (e.g., the display 220 of FIG. 2). The electronic device 101 may include at least one processor (e.g., the processor 240 of FIG. 2) including processing circuitry. The electronic device 101 may include memory (e.g., the memory 230 of FIG. 2) storing instructions. The instructions, when executed by the at least one processor 240 individually or collectively, may cause the electronic device 101 to display a lock screen for user authentication through the display 220, based on an event for subscriber identity module (SIM) authentication being generated. The instructions, when executed by the at least one processor 240 individually or collectively, may cause the electronic device 101 to acquire a personal identification number (PIN) for SIM unlock, based on user authentication information for releasing the lock screen being acquired. The instructions, when executed by the at least one processor 240 individually or collectively, may cause the electronic device 101 to identify whether the acquired PIN corresponds to a stored PIN. The instructions, when executed by the at least one processor 240 individually or collectively, may cause the electronic device 101 to perform the SIM unlock, based on identification that the acquired PIN corresponds to the stored PIN.

In an embodiment, instructions, when executed by the at least one processor 240 individually or collectively, may cause the electronic device 101 to display a user interface for acquiring user authentication information through the display 220, based on an event for activating a SIM authentication function using an auto-generated PIN (AGP) being identified. The instructions, when executed by the at least one processor 240 individually or collectively, may cause the electronic device 101 to acquire the user authentication information, based on an input to the user interface. The instructions, when executed by the at least one processor 240 individually or collectively, may cause the electronic device 101 to acquire identification information of the electronic device 101 and identification information of the SIM, based on user authentication being performed using the user authentication information. The instructions, when executed by the at least one processor 240 individually or collectively, may cause the electronic device 101 to acquire a PIN for configuring SIM authentication information, based on the identification information of the electronic device 101, the identification information of the SIM, and a random value. The instructions, when executed by the at least one processor 240 individually or collectively, may cause the electronic device 101 to store the PIN for configuring the SIM authentication information.

In an embodiment, instructions, when executed by the at least one processor 240 individually or collectively, may cause the electronic device 101 to acquire the identification information of the electronic device 101 and the identification information of the SIM, based on the user authentication information for releasing the lock screen being acquired. The instructions, when executed by the at least one processor 240 individually or collectively, may cause the electronic device 101 to acquire the PIN for the SIM unlock, based on the identification information of the electronic device 101, the identification information of the SIM, and the random value. The instructions, when executed by the at least one processor 240 individually or collectively, may cause the electronic device 101 to establish a connection with a network through the communication circuit 210, based on the PIN for the SIM unlock corresponding to the stored PIN.

In an embodiment, instructions, when executed by the at least one processor 240 individually or collectively, may cause the electronic device 101 to store, in the memory 230 of the electronic device 101, an encrypted random value acquired using a key for encrypting the random value or decrypting the encrypted random value. The instructions, when executed by the at least one processor 240 individually or collectively, may cause the electronic device 101 to acquire the decrypted random value by using the key, based on the user authentication information for releasing the lock screen being acquired. The instructions, when executed by the at least one processor 240 individually or collectively, may cause the electronic device 101 to acquire the PIN for the SIM unlock, based on the identification information of the electronic device 101, the identification information of the SIM, and the decrypted random value.

In an embodiment, instructions, when executed by the at least one processor 240 individually or collectively, may cause the electronic device 101 to identify whether user authentication information for user authentication is configured based on the event for activating the SIM authentication function using the PIN being identified. The instructions, when executed by the at least one processor 240 individually or collectively, may cause the electronic device 101 to display a user interface for configuring the user authentication information through the display 220, based on identification that the user authentication information for the user authentication is not configured. The instructions, when executed by the at least one processor 240 individually or collectively, may cause the electronic device 101 to acquire the user authentication information, based on an input to the user interface. The instructions, when executed by the at least one processor 240 individually or collectively, may cause the electronic device 101 to store the acquired user authentication information in the memory 230.

In an embodiment, the instructions, when executed by the at least one processor 240 individually or collectively, may cause the electronic device 101 to display a user interface for acquiring user authentication information through the display 220, based on an input for displaying the stored PIN being acquired. The instructions, when executed by the at least one processor 240 individually or collectively, may cause the electronic device 101 to acquire the user authentication information, based on an input to the user interface. The instructions, when executed by the at least one processor 240 individually or collectively, may cause the electronic device 101 to display a user interface including the stored PIN through the display 220, based on the acquired user authentication information corresponding to stored user authentication information.

In an embodiment, the instructions, when executed by the at least one processor 240 individually or collectively, may cause the electronic device 101 to acquire an update PIN, based on a random value different from the random value after displaying the user interface including the stored PIN. The instructions, when executed by the at least one processor 240 individually or collectively, may cause the electronic device 101 to configure the updated PIN as the PIN for the SIM unlock.

In an embodiment, the instructions, when executed by the at least one processor 240 individually or collectively, may cause the electronic device 101 to deactivate the function related to the SIM lock by changing the stored PIN into a configured value, based on an event for deactivating the SIM authentication function using the auto-generated PIN being identified. The instructions, when executed by the at least one processor 240 individually or collectively, may cause the electronic device 101 to display a user interface for acquiring user authentication information through the display 220, based on an event for activating a SIM authentication function using a manual PIN being identified while the function related to the SIM lock is deactivated. The instructions, when executed by the at least one processor 240 individually or collectively, may cause the electronic device 101 to acquire the user authentication information, based on an input to the user interface. The instructions, when executed by the at least one processor 240 individually or collectively, may cause the electronic device 101 to display a user interface for acquiring the manual PIN through the display 220, based on the user authentication information corresponding to stored user authentication information. The instructions, when executed by the at least one processor 240 individually or collectively, may cause the electronic device 101 to configure the manual PIN acquired based on the input to the user interface for acquiring the manual PIN as the PIN for the SIM unlock.

In an embodiment, instructions, when executed by the at least one processor 240 individually or collectively, may cause the electronic device 101 to display a user interface for acquiring a PIN through the display 220, based on identification that the acquired PIN does not correspond to the stored PIN. The instructions, when executed by the at least one processor 240 individually or collectively, may cause the electronic device 101 to identify whether the PIN identified based on an input to the user interface corresponds to the stored PIN. The instructions, when executed by the at least one processor 240 individually or collectively, may cause the electronic device 101 to perform an operation related to the SIM lock, based on identification that the PIN identified based on the input does not correspond to the stored PIN.

In an embodiment, the identification information of the electronic device 101 may include an international mobile equipment identity (IMEI) of the electronic device 101. The identification information of the SIM may include an integrated circuit card identifier (ICCID) of the SIM. The instructions, when executed by the at least one processor 240 individually or collectively, may cause the electronic device 101 to input the IMEI, the ICCID, and the random value into a key derivation function so as to acquire the PIN for the SIM unlock, based on information output from the key derivation function.

In an embodiment, the instructions, when executed by the at least one processor 240 individually or collectively, may cause the electronic device 101 to initiate a timer for periodically updating the PIN, based on the PIN for the SIM unlock being acquired. The instructions, when executed by the at least one processor 240 individually or collectively, may cause the electronic device 101 to acquire the updated PIN, based on a random value different from the random value, based on lapse of a time interval corresponding to the timer. The instructions, when executed by the at least one processor 240 individually or collectively, may cause the electronic device 101 to configure the updated PIN as the PIN for the SIM unlock.

In an embodiment, the instructions, when executed by the at least one processor 240 individually or collectively, may cause the electronic device 101 to convert the acquired PIN into an encrypted PIN, based on identification that the acquired PIN corresponds to the stored PIN. The instructions, when executed by the at least one processor 240 individually or collectively, may cause the electronic device 101 to transmit the encrypted PIN to a cloud server through the communication circuit 210.

In an embodiment, the event for the SIM authentication may include an event of inserting the SIM into the electronic device 101.

In an embodiment, the event for the SIM authentication may include an event of rebooting the electronic device 101.

A method of operating the electronic device 101 according to an embodiment may include an operation of displaying a lock screen for user authentication through a display 220 of the electronic device 101, based on an event for subscriber identity module (SIM) authentication being generated. The method may include an operation of acquiring a personal identification number (PIN) for SIM unlock, based on user authentication information for releasing the lock screen being acquired. The method may include an operation of identifying whether the acquired PIN corresponds to a stored PIN. The method may include an operation of performing the SIM unlock, based on identification that the acquired PIN corresponds to the stored PIN.

In an embodiment, the method may further include an operation of displaying a user interface for acquiring user authentication information through the display 220, based on an event for activating a SIM authentication function using an auto-generated PIN (AGP) being identified. The method may further include an operation of acquiring the user authentication information, based on an input to the user interface. The method may further include an operation of acquiring identification information of the electronic device 101 and identification information of the SIM, based on user authentication being performed using the user authentication information. The method may further include an operation of acquiring a PIN for configuring SIM authentication information, based on the identification information of the electronic device 101, the identification information of the SIM, and a random value. The method may further include an operation of storing the PIN for configuring the SIM authentication information.

In an embodiment, the operation of acquiring the PIN for the SIM unlock, based on the user authentication information for releasing the lock screen being acquired may include an operation of acquiring the identification information of the electronic device 101 and the identification information of the SIM, based on the user authentication information for releasing the lock screen being acquired. The operation of acquiring the PIN for the SIM unlock, based on the user authentication information for releasing the lock screen being acquired may include an operation of acquiring the PIN for the SIM unlock, based on the identification information of the electronic device 101, the identification information of the SIM, and the random value. The method may further include an operation of establishing a connection with a network through a communication circuit 210 of the electronic device 101, based on the PIN for the SIM unlock corresponding to the stored PIN.

In an embodiment, the method may further include an operation of storing, in memory 230 of the electronic device 101, an encrypted random value acquired using a key for encrypting the random value or decrypting the encrypted random value. The operation of acquiring the PIN for the SIM unlock, based on the user authentication information for releasing the lock screen being acquired may include an operation of acquiring the decrypted random value by using the key, based on the user authentication information for releasing the lock screen being acquired. The operation of acquiring the PIN for the SIM unlock, based on the user authentication information for releasing the lock screen being acquired may include an operation of acquiring the PIN for the SIM unlock, based on the identification information of the electronic device 101, the identification information of the SIM, and the decrypted random value.

In an embodiment, the method may further include an operation of identifying whether user authentication information for user authentication is configured based on the event for activating the SIM authentication function using the PIN being identified. The method may further include an operation of displaying a user interface for configuring the user authentication information through the display 220, based on identification that the user authentication information for the user authentication is not configured. The method may further include an operation of acquiring the user authentication information, based on an input to the user interface. The method may further include an operation of storing the acquired user authentication information in the memory 230 of the electronic device 101.

A non-transitory computer-readable storage medium recording computer-executable instructions according to an embodiment may be provided. The computer-executable instructions, when executed by at least one processor 240 including processing circuitry of an electronic device 101 individually or collectively, may cause the electronic device 101 to display a lock screen for user authentication through a display 220 of the electronic device 101, based on an event for subscriber identity module (SIM) authentication being generated. The computer-executable instructions may be configured to, when individually or collectively executed by at least one processor 240, cause the electronic device 101 to acquire a personal identification number (PIN) for SIM unlock, based on user authentication information for releasing the lock screen being acquired. The computer-executable instructions may be configured to, when individually or collectively executed by at least one processor, cause the electronic device 101 to identify whether the acquired PIN corresponds to a stored PIN. The computer-executable instructions may be configured to, when individually or collectively executed by at least one processor 240, cause the electronic device 101 to perform the SIM unlock, based on identification that the acquired PIN corresponds to the stored PIN.

The structure of data used in the embodiments of the disclosure may be recorded in a computer-readable recording medium through various means. The computer-readable recording medium includes a magnetic storage medium (e.g., a ROM, a floppy disk, and a hard disk) and an optical reading medium (e.g., a CD-ROM and a DVD).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a communication circuit;
a display;
at least one processor including processing circuitry; and
memory storing instructions that, when executed by the at least one processor individually or collectively, cause the electronic device to:
display a lock screen for user authentication through the display based on an event for subscriber identity module (SIM) authentication being generated,
acquire a personal identification number (PIN) for an SIM unlock based on acquisition of user authentication information for releasing the lock screen,
identify whether the acquired PIN corresponds to a stored PIN, and
perform the SIM unlock, based on identifying that the acquired PIN corresponds to the stored PIN.

2. The electronic device of claim 1, wherein the instructions, when executed by the at least one processor individually or collectively, cause the electronic device to:
display a user interface for acquisition of the user authentication information through the display based on identification of an event for activating a SIM authentication function using an auto-generated PIN (AGP),
acquire the user authentication information based on an input to the user interface for acquisition of the user authentication information,
acquire identification information of the electronic device and identification information of the SIM based on user authentication being performed using the user authentication information,
acquire a PIN for configuration of SIM authentication information based on (i) the identification information of the electronic device, (ii) the identification information of the SIM, and (iii) a random value, and
store the PIN for configuration of the SIM authentication information.

3. The electronic device of claim 2, wherein the instructions, when executed by the at least one processor individually or collectively, cause the electronic device to:
acquire the identification information of the electronic device and the identification information of the SIM based on acquistion of the user authentication information for releasing the lock screen,
acquire the PIN for the SIM unlock based on (i) the identification information of the electronic device, (ii) the identification information of the SIM, and (iii) the random value, and
establish a connection with a network through the communication circuit based on the PIN for the SIM unlock corresponding to the stored PIN.

4. The electronic device of claim 3, wherein the instructions, when executed by the at least one processor individually or collectively, cause the electronic device to:
store, in the memory, an encrypted random value acquired using a key for encrypting the random value or decrypting the encrypted random value,
acquire a decrypted random value by using the key on the encrypted random value based on acquisition of the user authentication information for releasing the lock screen, and
acquire the PIN for the SIM unlock based on (i) the identification information of the electronic device, (ii) the identification information of the SIM, and (iii) the decrypted random value.

5. The electronic device of claim 1, wherein the instructions, when executed by the at least one processor individually or collectively, cause the electronic device to:
identify whether the user authentication information for user authentication is configured based on identification of the event for activating an SIM authentication function using the PIN,
display a user interface for configuration of the user authentication information through the display based on identifying that the user authentication information for user authentication is not configured,
acquire the user authentication information based on an input to the user interface, and
store the acquired user authentication information in the memory.

6. The electronic device of claim 1, wherein the instructions, when executed by the at least one processor individually or collectively, cause the electronic device to:
display a user interface for acquisition of the user authentication information through the display based on acquisition of an input for displaying the stored PIN,
acquire the user authentication information based on the input to the user interface, and
display a user interface comprising the stored PIN through the display based on the acquired user authentication information corresponding to stored user authentication information.

7. The electronic device of claim 2, wherein the instructions, when executed by the at least one processor individually or collectively, cause the electronic device to:
acquire, after displaying the user interface comprising the stored PIN, an updated PIN using a different random value generated from the random value,, and
configure the updated PIN as the PIN for the SIM unlock.

8. The electronic device of any claim 2, wherein the instructions, when executed by the at least one processor (240) individually or collectively, cause the electronic device to:
deactivate a function related to an SIM lock based on identificiation of an event for deactivating the SIM authentication function using the AGP, the function related to the SIM lock deactivated by changing the stored PIN to a configured value,
display, while the function related to the SIM lock is deactivated, the user interface for acquisition of the user authentication information through the display based on identification of an event for activating the SIM authentication function using a manual PIN,
acquire the user authentication information based on an input to the user interface,
display a user interface for acquisition of the manual PIN through the display based on the user authentication information corresponding to the stored user authentication information, and
configure the manual PIN acquired based on an input to the user interface for acquisition of the manual PIN as the PIN for the SIM unlock.

9. The electronic device of claim 1, wherein the instructions, when executed by the at least one processor individually or collectively, cause the electronic device to:
display a user interface for acquisition of a PIN through the display,
identify whether the PIN input to the user interface corresponds to the stored PIN, and
perform an operation related to SIM lock based on identifying that the PIN acquired based on the input does not correspond to the stored PIN.

10. The electronic device of claim 2, wherein the identification information of the electronic device comprises an international mobile equipment identity (IMEI) of the electronic device,
wherein the identification information of the SIM comprises an integrated circuit card identifier (ICCID) of the SIM, and
wherein the instructions, when executed by the at least one processor individually or collectively, cause the electronic device to:
input the IMEI, the ICCID, and the random value into a key derivation function to acquire the PIN for the SIM unlock based on information output from the key derivation function.

11. The electronic device of claim 10, wherein the instructions, when executed by the at least one processor individually or collectively, cause the electronic device to:
start a timer for periodically updating the PIN based on acquisition of the PIN for the SIM unlock,
acquire, based on elapse of a time interval corresponding to the timer, an updated PIN based on a different random value generated from the random value, and
configure the updated PIN as the PIN for the SIM unlock.

12. The electronic device of claim 1, wherein the instructions, when executed by the at least one processor individually or collectively, cause the electronic device to:
convert the acquired PIN into an encrypted PIN based on identifying that the acquired PIN corresponds to the stored PIN, and
transmit the encrypted PIN to a cloud server through the communication circuit.

13. The electronic device of claim 1, wherein the event for an SIM authentication comprises an event of insertion of the SIM into the electronic device.

14. The electronic device of claim 13, wherein the event for the SIM authentication comprises an event of rebooting the electronic device.

15. A method for operating an electronic device, the method comprising:
displaying a lock screen for user authentication through a display of the electronic device based on an event for subscriber identity module (SIM) authentication being generated;
acquiring a personal identification number (PIN) for an SIM unlock based on acquiring user authentication information for releasing the lock screen;
identifying whether the acquired PIN corresponds to a stored PIN; and
performing the SIM unlock, based on identification that the acquired PIN corresponds to the stored PIN.

16. The method of claim 15, further comprising:
displaying a user interface for acquisition of the user authentication information through the display based on identifying an event for activating a SIM authentication function using an auto-generated PIN (AGP);
acquiring the user authentication information based on an input to the user interface;
acquiring identification information of the electronic device and identification information of the SIM based on user authentication being performed using the user authentication information;
acquiring a PIN for configuration of SIM authentication information based on (i) the identification information of the electronic device, (ii) the identification information of the SIM, and (iii) a random value; and
storing the PIN for configuration of the SIM authentication information.

17. The method of claim 16, wherein the acquiring of the PIN for the SIM unlock based on acquiring the user authentication information for releasing the lock screen, further comprises:
acquiring the identification information of the electronic device and the identification information of the SIM based on acquiring the user authentication information for releasing the lock screen; and
acquiring the PIN for the SIM unlock based on (i) the identification information of the electronic device, (ii) the identification information of the SIM, and (iii) the random value, and
wherein the method further comprises:
establishing a connection with a network through a communication circuit of the electronic device, based on the PIN for the SIM unlock corresponding to the stored PIN.

18. The method of claim 16, further comprising:
storing, in memory of the electronic device, an encrypted random value acquired using a key for encrypting the random value or decrypting the encrypted random value,
wherein the acquiring of the PIN for the SIM unlock based on the user authentication information for releasing the lock screen being acquired, further comprises:
acquiring a decrypted random value by using the key on the encrypted random value based on the user authentication information for releasing the lock screen being acquired; and
acquiring the PIN for the SIM unlock based on (i) the identification information of the electronic device, (ii) the identification information of the SIM, and (iii) the decrypted random value.

19. The method of claim 18, further comprising:
identifying whether the user authentication information for user authentication is configured based on identifying the event for activating an SIM authentication function using the PIN;
displaying a user interface for configuration of the user authentication information through the display based on identifying that the user authentication information for the user authentication is not configured;
acquiring the user authentication information, based on an input to the user interface for configuration of the user authentication information; and
storing the acquired user authentication information in the memory of the electronic device.

20. A non-transitory computer-readable storage medium recording computer-executable instructions, the computer-executable instructions, when executed by at least one processor including processing circuitry of an electronic device individually or collectively, causing the electronic device to:
display a lock screen for user authentication through a display of the electronic device, based on an event for subscriber identity module (SIM) authentication being generated,
acquire a personal identification number (PIN) for an SIM unlock, based on acquisition of user authentication information for releasing the lock screen,
identify whether the acquired PIN corresponds to a stored PIN, and
perform the SIM unlock, based on identifying that the acquired PIN corresponds to the stored PIN.
